(19) United States
(12) Patent Application Publication
(10) Pub. No.: US 2025/0125972 A1
(43) Pub. Date: Apr. 17, 2025

(54) GENERATING DIGITAL SIGNATURES

(71) Applicant: nChain Licensing AG, Zug (CH)

(72) Inventor: Michaella PETTIT, London (GB)

(21) Appl. No.: 18/682,089

(22) PCT Filed: Jul. 11, 2022
(86) PCT No.: PCT/EP2022/069246

§ 371 Date: Feb. 7, 2024

(30) Foreign Application Priority Data
Aug. 9, 2021 (GB) 211141.8

(51) Int. Cl. H04L 9/32

(52) U.S. Cl. CPC H04L 9/3247

(57) ABSTRACT

A computer-implemented method of generating a digital signature for signing a message, wherein the method is performed by a coordinating party and comprises: obtaining at least the threshold number of respective signature shares; obtaining, for each of the respective signature shares, a respective commitment of the respective signature share, each respective commitment having been generated by the respective participant that generated the respective signature share; generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment; generating the signature based on at least the threshold number of respective signature shares; and making a Merkle root of the Merkle tree available to at least the respective participants that generated a signature share.

### CROSS REFERENCE TO RELATED APPLICATIONS

This application is the U.S. National Stage of International Application No. PCT/EP2022/069246 filed on Jul. 11, 2022, which claims the benefit of United Kingdom Patent Application No. 211141.8, filed on Aug. 9, 2021, the contents of which are incorporated herein by reference in their entireties.

### TECHNICAL FIELD

The present disclosure relates to a method of generating a digital signature and to a method proving that a participant contributed a share of the digital signature.

### BACKGROUND

In general, a shared secret may be used to share a data item that is distributed amongst a group of participants. Each participant has a different share of the secret. Normally, the secret can only be reconstructed when a certain number (referred to as the “threshold”) of participants make their respective shares available, e.g. to be combined together to calculate the secret.

Public-key cryptography is a type of cryptographic system that uses pairs of keys: private keys which are known only to the owner of the private key, and public keys which are generated based on the corresponding private key and which may be disseminated without compromising the security of the private key.

Public-key cryptography enables a sender to encrypt a message using a recipient's public key (i.e. the public key corresponding to a private key known only to the recipient). The encrypted message can then only be decrypted using the recipient's private key.

Similarly, a sender can use their own private key to sign a message, e.g. to prove that the message is being sent by the sender, and/or to indicate that the sender agrees with the message. The signer (i.e. the party generating the signature) uses their private key to create a digital signature based on the message. Creating a digital signature based on a message means supplying the message and private key to a function that generate the signature based on both the message and private key. The signature is added to (e.g. tagged onto) the message or otherwise associated with the message. Anyone with the signer's corresponding public key can use the same message and the digital signature on the message to verify whether the signature was validly created, i.e. whether the signature was indeed made using the signer's private key. As well as ensuring the authenticity of a message, digital signatures also ensure the integrity and non-repudiation of the message. That is, a digital signature can be used to prove that a message has not been changed since it was signed with the signature, and that the creator of a signature cannot deny in the future that they created the signature.

A digital signature scheme typically involves three procedures, i.e. algorithms. A key generation algorithm is used to generate a random private key and a corresponding public key. A signing algorithm is used to generate a signature based on a message and the private key. A verification algorithm is used to verify, given a public key and the message, whether the signature has been generated using the corresponding private key and according to the signing algorithm.

A common use of a shared secret is as a shared private key of a private-public key pair. That is, the private key may be distributed amongst a group of participants such that no single participant has access to the private key. Therefore no single participant can generate a valid signature of a message. Instead, some or all of the participants must together generate the private key in order for the signature to be generated.

Instead of the participants sharing their private key shares in order to generate a signature, they may instead use a threshold signature scheme. A threshold signature scheme allows a threshold number of participants in a group to create a digital signature based on a message using individual shares of a shared private key, without the private key being made available to any one participant. Here, a digital signature is a signature which is generated based on the message to be signed. In such a scheme, the signature can only be created if the threshold number of participants agree to generate the signature on the message. Any attempt to generate a signature using a smaller number of participants will not generate a valid signature. Therefore, a valid signature by the group (i.e. one generated using the message and the shared private key) provably had the threshold number of people agree to generate the signature. This also implies that any adversary needs to obtain the threshold number of shares of the private key to forge a signature with that private key.

### SUMMARY

As mentioned above, threshold signature schemes require participants to contribute respective signature shares in order to generate a valid signature. Whilst a valid signature proves that at least a threshold number of participants contributed a signature share, it does not prove which participants of the group contributed a signature share. In other words, in a threshold signature scheme, there is no way to identify who has created a given signature-the resulting signature will always be the same no matter which shares were used to create it. There is therefore a need for a threshold signature scheme which allows signers (i.e. participants that contribute to the signature) to be able to prove that they have indeed contributed a signature share. Such a scheme could be used to prevent other participants falsely claiming that they have contributed to the signature, or that the proving party has not contributed to the signature.

According to one aspect disclosed herein, there is provided a computer-implemented method of generating a digital signature for signing a message, wherein each participant of a group of participants has a respective private key share of a shared private key, wherein the shared private key can only be generated with at least a threshold number of respective private key shares, wherein each participant is associated with a respective participant index, and wherein the method is performed by a coordinating party and comprises: obtaining at least the threshold number of respective signature shares, each respective signature having been generated by a respective participant based on the respective private key share; obtaining, for each of the respective signature shares, a respective commitment of the respective signature share, each respective commitment having been generated by the respective participant that generated the respective signature share; generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment; generating the signature based on at least the threshold number of respective signature shares; and making a Merkle root of the Merkle tree available to at least the respective participants that generated a respective signature share.

According to one aspect disclosed herein, there is provided a computer-implemented method, performed by a first participant of a group of a participants, of proving that the first participant has generated a respective signature share of a digital signature for signing a message, wherein each participant of the group has a respective private key share of a shared private key, wherein the shared private key can only be generated with at least a threshold number of respective private key shares, wherein each participant is associated with a respective participant index, and wherein the method comprises: generating a first signature share based on a first private key share and the message; generating a first commitment of the first signature share, providing a) the first signature share and b) the first commitment to a coordinating party for generating, respectively, a) a signature based on at least the threshold number of respective signature shares, and b) a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment; obtaining a Merkle root of the Merkle tree; obtaining a Merkle proof based on a respective leaf node of the Merkle tree that is generated based on the respective participant index associated with the first participant; and providing at least the Merkle proof, the first commitment and the first participant index to a verifying party for verifying that a leaf node of the Merkle tree having the Merkle root was generated based on the first commitment and the first participant index, thereby verifying that the coordinating party generated the signature based on the first signature share.

Each participant is associated with an index. The coordinating party (or coordinator) receives the threshold number of signature shares, or more, and constructs a signature based on those signature shares. In general any threshold signature scheme may be used to generate the signature shares and construct the signature. The coordinator also receives, from each participants that contributes a signature share, a commitment of that signature share. In some examples, the commitment is the signature share itself, or a hash of the signature share. In other examples, the commitment is not based on the signature share, but is based on data unique to the participant and can be linked to or associated with the signature share. The coordinator uses the commitments to construct a Merkle tree, where at least some (or each, depending on the number of received signature shares) leaf hashes of the Merkle tree are based on a respective index and a respective commitment, where the index is associated with the participant that provided the commitment. The coordinator provides the Merkle root of the tree to the participants, e.g. by publishing the Merkle root on the blockchain.

When a participant wants to prove that they contributed to the signature share, they can provide to a verifying party i) their index, ii) their commitment, and iii) a Merkle proof for proving that their index and commitment were used to generate a leaf hash that forms part of a Merkle tree having the (published) Merkle root. In that way, the proving participant proves that the coordinator generated the signature based on the proving participant's signature share, as only the proving participant (out of the participants, not including the coordinator) has access to their commitment which was used by the coordinator to construct the Merkle tree.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing embodiments of the present invention, and

FIG. 2 schematically represents a Merkle tree corresponding to eight signers in a threshold signature scheme,

FIG. 3 is a flow diagram illustrating an example embodiment of the present invention, and

FIG. 4 is a flow diagram illustrating an example signature generation method according to some embodiments of the present invention.

### DETAILED DESCRIPTION OF EMBODIMENTS

### 1. Cryptographic Preliminaries

Whilst the following examples are described in terms of elliptic curve cryptography, the invention is not limited to any one particular cryptographic scheme and may in general be applied to any cryptographic scheme, e.g. RSA or other public key cryptography schemes.

### 1.1 Elliptic Curve Groups

An elliptic curve E satisfies the equation:

$${y}^{2} = {x}^{3} + a x + b mod p$$

where a, b ∈ [symbol] ₚ and a, b are constants satisfying 4a³+27b²+0. The group over this elliptic curve is defined to be the set of elements (x, y) satisfying this equation along with the point at infinity [symbol] , which is the identity element. The group operation on the elements in this group is called elliptic curve point addition and denoted by +. This group is denoted by E( [symbol] ₚ) and its order by n.

This group operation can be used to define another operation on the elements called point multiplication denoted by ·. For a point G ∈ E ( [symbol] ₚ) and a scalar k ∈ [symbol] 8ₙ, the point k·G is defined to be the point G added to itself k times.

In elliptic curve cryptography, a private key is defined to be a scalar k ∈ [symbol] ₙ\{0} where [symbol] ₙ\{0} is notation for the set {1, . . . , n−1}, and the corresponding public key is the point k·G on an elliptic curve. For instance, in some blockchain protocols, the elliptic curve is chosen to be the secp256k1 elliptic curve, and the values a, b, and p are completely specified by this curve. The order n of this group has been calculated given these values, which in the case of this curve is a prime, and the secp256k1 standard also specifies a point G which is to be used as the generator of this group.

### 1.2 Elliptic Curve Digital Signature Algorithm

In order to create a signature on a message msg, with the private key a, the following steps are taken:
1. Calculate the message digest e=hash(msg), where may be any hash function. For instance, in some examples hash(msg)=SHA256(SHA256(msg)) where SHA256(▪) is the SHA-256 hash function. Note that instead the message may be hashed only once, or more that two times with the same or different hash functions.
2. Chose a random integer k ∈{1, . . . , n−1}, where n is the order of the elliptic curve, e.g. the secp256k1 curve. In the following, k is referred to as the ephemeral private key.
3. Calculate the ephemeral public key corresponding to this ephemeral private key k·G=(Rₓ, R_{y}).
4. Calculate r=Rₓ mod n. If r=0, return to step 2.
5. Calculate the multiplicative inverse of the ephemeral key k⁻¹ mod n.
6. Calculate s=k⁻1(e+ar) mod n. If s=0, return to step 2.
7. The signature on the message msg is (r, s).

The ephemeral key must be kept secret, otherwise the private key can be calculated, given a message and signature. Additionally, each time a signature is generated, a different ephemeral key must be used. If this is not the case, it is possible to derive the private key a given two different signatures and their corresponding messages.

Given a message msg, a public key P=a·G, and corresponding signature (r, s), then one can verify the signature by completing the following steps:
1. Calculate the message digest e=hash(msg), e.g. e=SHA256(SHA256(msg)).
2. Calculate the multiplicative inverse s⁻¹ of s modulo n.
3. Calculate j₁=es⁻¹ mod n and j₂=rs⁻¹ mod n.
4. Calculate the point Q=j₁·G+j₂·P.
5. If Q= [symbol] , the point at infinity, the signature is invalid.
6. If Q≠ [symbol] , then let Q:=(Qₓ, Q_{y}), and calculate u=Qₓ mod n. If u=r, the signature is valid.

In threshold signature schemes, this private key a is split into key shares that are distributed amongst participants in a threshold scheme group.

### 1.3 Joint Verifiable Random Secret Sharing

Assume that N participants want to create a joint secret that can only be regenerated by at least (t+1) of the participants in the scheme. To create the shared secret, the following steps are taken:
1. The participants agree on the unique label i for each participant. Each participant i generates (t+1) random numbers

$${a}_{i j} {∈}_{R} {ℤ}_{n} ∖ \{ 0 \} , ∀ j = 0 , … , t ,$$

where ∈_{R} means a randomly generated element of the set [symbol] ₙ\{0} where [symbol] ₙ\{0} is notation for the set {1, . . . , n−1}. Then each participant has a secret polynomial of order t

$${f}_{i} ( x ) = {a}_{i 0} + {a}_{i 1} x + … + {a}_{i t} {x}^{t} mod n ,$$

for i=1, . . . , N. Note that we omit the mod n notation from now on, and it is assumed that all arithmetic operations over integers are done modulo n.
2. Each participant i sends the value ƒᵢ(j) to participant j e.g. using a secure communication channel with participant j only.
3. Each participant i calculates their own private secret share of a shared secret polynomial as

$${a}_{i} := {\sum }_{j = 1}^{N} {f}_{j} ( i ) .$$

A shared secret share is a point with the form (i, aᵢ), where i is the participants label in the scheme. This method for creating a secret share of a, as described in steps 1-3, is denoted herein by aᵢ=JVRSS(i) for participant i. Note that “JVRSS” typically stands for “Joint verification random secret sharing” and includes steps 4 and 5 as well. However, throughout this document JVRSS is taken to mean performing at least steps 1 to 3, where steps 4 and 5 are optional steps.

Now that the participants have generated a shared polynomial, they can each verify that the other participants have shared the correct information to all participants, and that all participants have the same shared polynomial. This is done in the following way.
4. Each participant i broadcasts to all participants the obfuscated coefficients

aᵢₖ·G,

for k=0, . . . , t.
5. Each participant i checks that each participant j has correctly calculated the polynomial point ƒⱼ(i) by calculating ƒⱼ(i)·G and verifying that

$${f}_{j} ( i ) \cdot G {=}^{?} {\sum }_{k = 0}^{t} {i}^{k} ( {a}_{j k} \cdot G ) ∀ j = 1 , … , N .$$

If all participants find that this equation holds for each polynomial, then the group can collectively be sure that they have all created the same shared polynomial.

### 1.4 Reconstructing a Shared Secret

Assume a participant wants to reconstruct a shared secret a which is the zeroth order of a shared polynomial. Given (t+1) points on this polynomial of the form

(1, a₁), . . . , ((t+1), aₜ₊₁),

then to find the shared secret a, one calculates

$$interpolate ( {a}_{1} , … , {a}_{t + 1} ) = ( {{\sum }_{l = 1}}^{t + 1} {a}_{l} {{\prod }_{1 \leq j \leq ( t + 1 ) ,}}_{j \neq l} ( - j ) {( l - j )}^{- 1} ) = a ,$$

which is derived from a general formula known as “Lagrange Interpolation”.

### 1.5 Public Key Calculation

Given the N zeroth-order private polynomial coefficient public keys aᵢ₀·G for j=1, . . . , N shared in step 4 of JVRSS, each participant calculates the shared public key P using

$$P = a \cdot G = {\sum }_{j = 1}^{N} {a}_{j 0} \cdot G ,$$

corresponding to the shared secret a.

### 1.6 Addition of Shared Secrets

To calculate the addition of two shared secrets that are shared amongst a group of N participants, where each secret polynomial has order t, without any entity knowing the individual secrets, the following steps are taken:
1. Generate the first shared secret a, where participant i's share is given by aᵢ=JVRSS(i) for i=1, . . . , N with a threshold of (t+1).
2. Generate the second shared secret b, where participant i's share is given by bᵢ=JVRSS(i), with a threshold of (t+1).
3. Each participant i calculates their own additive share

$${v}_{i} = {a}_{i} + {b}_{i} mod n .$$

4. All participants broadcast their additive share vi to all other participants.
5. Each participant interpolates over at least (t+1) of the shares vᵢ to calculate

$$v = interpolate ( {v}_{1} , … , {v}_{t + 1} ) = a + b .$$

This method for the addition of shared secrets is denoted by ADDSS(i) for participant i, which results in each participant i knowing v=(a+b).

### 1.7 Product of Shared Secrets

To calculate the product of two shared secrets that are both shared amongst a group of N participants, where each secret polynomial has order t, the group takes the following steps:
1. Generate the first shared secret a, where participant i's share is given by aᵢ=JVRSS(i) for i=1, . . . , N. The shared secret polynomial has order t, meaning (t+1) participants are required to recreate it.
2. Generate the second shared secret b, where participant i's share is given by bᵢ=JVRSS(i), and the shared secret polynomial again has order t.
3. Each participant calculates their own multiplicative share μᵢ using

μᵢ=aᵢbᵢ.
4. All participants broadcast their multiplicative share μᵢ to all other participants.
5. Each participant interpolates over at least (2t+1) of the shares μᵢ at 0 to calculate

$$μ = inte r p o lat e ( {μ}_{1} , … , {μ}_{2 t + 1} ) = ab .$$

This method for calculating the product of two shared secrets is denoted herein by μ=ab=PROSS(i) for participant i.

### 1.8 Inverse of a Shared Secret

In order to calculate the inverse of a shared secret a, the following steps are taken:
1. All participants calculate the product of shared secrets PROSS(i), the result of which is μ=ab mod n.
2. Each participant calculates the modular inverse of u which results in

$${μ}^{- 1} = {( a b )}^{- 1} mod n .$$

3. Each participant i calculates their own inverse secret share by calculating

$${a}_{i}^{- 1} = {μ}^{- 1} {b}_{i} .$$

This method for calculating the inverse of shared secrets is denoted by aᵢ⁻¹=INVSS(i) for participant i.

### 1.9 Shared Private Key Generation and Verification

To calculate a shared private key a between N≥2t+1 participants, t+1 of which are required to create a signature, the participants execute JVRSS with a threshold of t+1 and public key calculation as described above. The result is that every participant i=1, . . . , N has a private key share a and the corresponding shared public key P=(a·G).

### 1.10 Ephemeral Key Shares Generation

To generate ephemeral key shares and the corresponding r, as is required in a signature, a group of size N with a shared private key a of threshold (t+1) execute the following steps:
1. Generate the inverse share of a shared secret kᵢ⁻¹=INVSS(i), where (t+1) shares are required to recreate it.
2. Each participant calculates

$$( x , y ) = {\sum }_{i = 1}^{N} ( {k}_{i 0} \cdot G ) ,$$

using the obfuscated coefficients shared in the verification of kᵢ, then they calculate

r=x mod n.
3. Each participant i stores (r, kᵢ⁻¹).

### 1.11 Non-Optimal Signature Generation

Assume that at least 2t+1 participants would like to create a signature on a message, and one of the participants chooses to coordinate this. In order to create a signature by a group with the shared private key a, the following steps are taken.
1. The coordinator requests a signature on the message from at least 2t+1 participants.
2. Each participant i recovers the ephemeral key (r, kᵢ⁻¹) calculated in the previous section. All users must use a share corresponding to the same ephemeral key.
3. Each participant calculates the message digest e=SHA-256(SHA-256(message)).
4. Each participant i calculates their own signature share sᵢ:

$${s}_{i} = {k}_{i}^{- 1} ( e + {a}_{i} r ) mod n ,$$

where aᵢ is their private key share.
5. Each participant sends their signature share (r, sᵢ) to the coordinator.
6. When the coordinator has received 2t+1 signature shares, they calculate:

$$s = interpolate ( {s}_{1} , … , {s}_{2 t + 1} ) ,$$

and output the signature as (r, s).
7. The coordinator verifies the signature using the standard ECDSA verification. If this fails, at least one of the shares must be incorrect, and the signature generation algorithm should be run again.
   1.12 Addition of Secrets with Different Thresholds

In the case of addition of secrets of order t and t′, the addition of the two secrets requires max (t, t′)+1 number of shares to calculate it. The reason behind this is that the addition step of the shares of the shared secrets creates a share of a new polynomial. This new additive polynomial is equivalent to the result of the addition of the individual polynomials of the two shared secrets. Adding two polynomials is adding the corresponding coefficients at each order of x. Therefore, the order of the additive polynomial must be the same order as the highest order of the two polynomials. This can be generalised to the addition of more than two polynomials, where the order of the resulting polynomial is the same as the order of the highest order individual polynomial.

Once the addition of two secrets with different thresholds has been calculated, the security of the higher threshold secret is reduced. This is because if one now knows the result (a+b) with respective thresholds t, t′ and assume that t<t′, then one can calculate a with t shares, and then calculate (a+b)−a=b, and so the value b has been calculated with only t shares. This lower threshold is referred to below as the ‘implicated threshold’ of b.

1.13 Multiplication of Secrets with Different Thresholds

In the case of multiplication of two secrets with a threshold of t and t′, the calculation of the multiplication requires t+t′+1 shares. In this case, the multiplication of shares of two polynomials results in a share on a new polynomial. This new polynomial is the result of multiplying the two individual polynomials and so the order of the result is the addition of the order of the two individual polynomials.

Multiplication can also be generalised to any number of shared secrets, with the resulting threshold being the sum of the individual thresholds plus 1, Σ_{ρ}t_{ρ+}1, where ρ runs over the individual shared secrets.

Similar to addition, the multiplication of two secrets with different thresholds results in an implicated threshold of the higher threshold secret. As before, if ab is known where a has a threshold of t and b has a threshold of t′, and t<t′, then both a and b can be calculated with t shares. First, one can calculate a and using (ab)a⁻¹ find b with only t shares of a secret.

### 1.14 Combining the Addition and Multiplication of Shared Secrets in One Step

It is possible to generalise the above to calculate any combination of addition and multiplication in one step. Assume a group of N participants want to calculate the result ab+c, where a, b, c are shared secrets with thresholds (tₐ+1), (t_{b}+1), (t_{c}+1) respectively. There is a condition which is max(tₐ+t_{b}, t_{c})<N, that is, the number of participants of the scheme must be greater than the maximum between the order of the secret c and the order of the result of the multiplication of the secrets a and b.
1. Each participant i calculates their secret shares aᵢ=JVRSS(i), bᵢ=JVRSS(i), cᵢ=JVRSS(i) with thresholds (tₐ+1), (t_{b}+1), (t_{c}+1) respectively.
2. Each participant i calculates the share λᵢ=aᵢbᵢ+cᵢ.
3. Each participant i shares the result λᵢ with the other participants.
4. Each participant interpolates over max(tₐ+t_{b}, t_{c})+1 shares to find the result λ=int(λ₁, . . . , λᵢ, . . . )=a_{b}+c.

This is done in the calculation of a shared signature according to some embodiments below. That is, there is an interpolation over sᵢ=kᵢ⁻¹(e+aᵢr). This is essentially the case above with aᵢbᵢ=kᵢ⁻¹aᵢr and cᵢ=kᵢ⁻¹e. In this case tₐ+t_{b}=2t and t_{c}=t, and interpolation is over max(tₐ+t_{b}, t_{c})+1=2t+1 shares.

### 1.16 Merkle Trees

Merkle Trees are hierarchical data structures that enable secure verification of collections of data. In a Merkle tree, each node in the tree has been given an index pair (i, j) and is represented as N(i, j). The indices i, j are simply numerical labels that are related to a specific position in the tree.

A feature of binary Merkle trees (a specific type of Merkle tree) is that the construction of each of its nodes is governed by the following equations

$$N ( i , j ) = \{ \begin{matrix}H ( {D}_{i} ) \\ H ( N ( i , k ) \vert \vert N ( k + 1 , j ) )\end{matrix} \begin{matrix}i = j \\ i \neq j\end{matrix} ,$$

where and H is a cryptographic hash function.

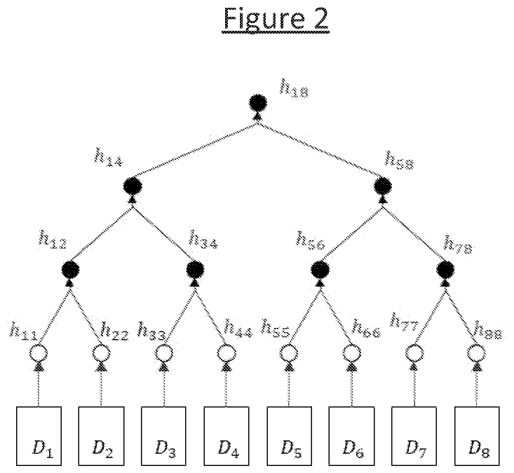

A binary Merkle tree constructed according to these equations is shown in FIG. 2. As shown the i=j case corresponds to a leaf node, which is simply the hash of the corresponding i^{th} packet of data Dᵢ. The i≠j case corresponds to an internal or parent node, which is generated by recursively hashing and concatenating child nodes until one parent (the Merkle root) is found.

For example, the node N(0,3) is constructed from the four data packets D₀, . . . , D₃ as

$$\begin{matrix}N ( 0 , 3 ) = H ( N ( 0 , 1 ) \vert \vert N ( 2 , 3 ) ) \\ = [ H ( N ( 0 , 0 ) \vert \vert N ( 1 , 1 ) ) \vert \vert H ( N ( 2 , 2 ) \vert \vert N ( 3 , 3 ) ) ] \\ = [ H ( H ( {D}_{0} ) \vert \vert H ( {D}_{1} ) ) \vert \vert H ( H ( {D}_{2} ) \vert \vert H ( {D}_{3} ) ) ] .\end{matrix}$$

The tree depth M is defined as the lowest level of nodes in the tree, and the depth m of a node is the level at which the node exists. For example, mᵣₒₒₜ=0 and m_{leaf}=M, where M=3 in FIG. 5.

For Merkle trees in Bitcoin and some other blockchains, the hash function is double SHA256, which is to apply the standard hash function SHA-256 twice: H(x)=SHA256(SHA256(x)).

### 1.17 Merkle Proofs

The primary function of a Merkle tree is to verify that some data packet Dᵢ is a member of a list or set of N data packets [symbol] ∈{D₀}, . . . , D_{N-1}. The mechanism for verification is known as a Merkle proof and involves obtaining a set of hashes known as the Merkle path for a given data packet Dᵢ and Merkle root R. The Merkle proof for a data packet is simply the minimum list of hashes required to reconstruct the root R by way of repeated hashing and concatenation, often referred to as the ‘authentication proof’.

A proof of existence could be performed trivially if all packets D₀, . . . , D_{N-1} and their order are known to the prover. This does however require a much larger storage overhead than the Merkle proof, as well as requiring that the entire data set is available to the prover. The comparison between using a Merkle proof and using the entire list is shown in the table below, where we have used a binary Merkle tree and assumed that the number of data blocks N is exactly equal to an integer power 2.

If, given a Merkle root R, we wish to prove that the data block D₀ belongs to the ordered list [symbol] ∈{D₀, . . . , D_{N-1}} represented by R we can perform a Merkle proof as follows, where the example Merkle tree comprises eight leaf hashes identified with indexes (0,0) to (7,7):
i. Obtain the Merkle root R from a trusted source.
ii. Obtain the Merkle proof Γ from a source. In this case, Γ is the set of hashes:

Γ={N(1,1), N(2,3), N(4,7)}.
iii. Compute a Merkle proof using D₁ and Γ as follows:
   a. Hash the data block to obtain:

N(0,0)=H(D₀).
b. Concatenate with N(1,1) and hash to obtain:

$$N ( 0 , 1 ) = H ( N ( 0 , 0 ) \vert \vert N ( 1 , 1 ) ) .$$

c. Concatenate with N(2,3) and hash to obtain:

$$N ( 0 , 3 ) = H ( N ( 0 , 1 ) \vert \vert N ( 2 , 3 ) ) .$$

d. Concatenate with N(4,7) and hash to obtain the root:

$$N ( 0 , 7 ) = H ( N ( 0 , 3 ) \vert \vert N ( 4 , 7 ) ) , {R}^{′} = N ( 0 , 7 ) .$$

e. Compare the calculated root R′ with the root R obtained in (i):
1. If R′=R, the existence of D₀ in the tree and therefore the data set [symbol] is confirmed.
2. If R′≠R, the proof has failed and D₀ is not confirmed to be a member of [symbol] .

This is an efficient mechanism for providing a proof of existence for some data as part of the data set represented by a Merkle tree and its root.

### 2. GENERATING SIGNATURE SHARES

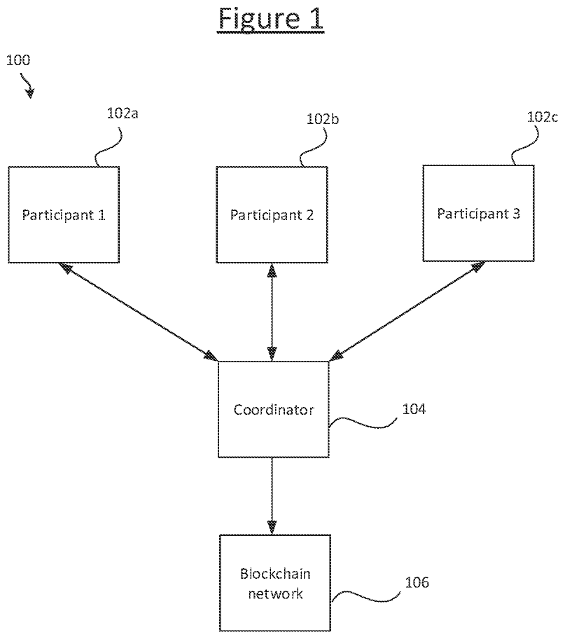

FIG. 1 illustrates an example system 100 for implementing embodiments of the invention. As shown, the system 100 comprises a plurality of parties (also referred to herein as “participants”) 102. Only three participants 102a, 102b, 102c are shown in FIG. 1, but it will be appreciated that in general the system may comprise any number of participants. The system 100 also comprises a coordinating party 104 (or simply, “coordinator”), who may or may not also be one of the participants 102. Each of the participants 102 and the coordinating party 104 operates respective computing equipment.

Each of the respective computing equipment comprises respective processing apparatus comprising one or more processors, e.g. one or more central processing units (CPUs), accelerator processors such a graphics processing units (GPUs), other application specific processors, and/or field programmable gate arrays (FPGAs). The respective computing equipment may also comprise memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The respective computing equipment may comprise at least one user terminal, e.g. a desktop or laptop computer, a tablet, a smartphone, or a wearable device such as a smartwatch. Alternatively or additionally, the respective computing equipment may comprise one or more other networked resources, such as cloud computing resources accessed via the user terminal (the cloud computing resources comprising resources of one or more physical server devices implemented at one or more sites). It will be appreciated that any act described as being performed by a party of the system 100 may be performed by the respective computing apparatus operated by that party.

Each of the participants 102 may be configured to transmit data to one, some or all of the other participants 102 over a network such as the Internet using a LAN or WAN connection, or via alternative wired or wireless communication means. Unless the context requires otherwise, reference to a participant 102 transmitting data may be understood as transmitting data to other participants 102 individually, e.g. via a secure communication channel between the first participant 102a and the second participant 102b, or broadcasting to the group as a whole, e.g. via email or other means. Again, unless the context requires otherwise, each participant 102 may transmit data in raw form, or in encrypted form. For instance, the data may be encrypted using a public key of a recipient participant before being sent to that recipient participant. The same applies to the coordinator 104 transmitting and receiving data to sone, some or all of the participants 102.

Embodiments of the present invention will primarily be described from the perspective of the first participant 102a. However it will be appreciated that in general steps of the described method may similarly be performed by other participants, e.g. the second participant 102b or third participant 102c. It will also be appreciated that the terms “first”, “second”, “third” and so on are used herein merely as distinguishing labels and do not necessarily imply an order, unless the particular context in which the terms are used requires otherwise.

The present invention enables each participant 102 of a group of participants 102 to generate respective shares of a threshold signature, and for a coordinator 104. Furthermore, the present invention enables a participant 102 to prove that they have contributed a respective share that was used to generate the threshold signature.

Each participant 102 has access to (e.g. stores in memory of their respective computing equipment) a respective share of a shared private key. These private keys shares may be generated using a secret sharing scheme such as, for example, JVRSS (described above) or Shamir's Secret Sharing Scheme (SSSS). Alternative schemes for generating shares of a shared private key may be used.

In some embodiments, each participant 102 also has access to a respective share of a shared ephemeral private key. The ephemeral private key shares may be generated using JVRSS, SSSS or an alternative scheme. Each participant 102 may also have access to the inverse of their respective ephemeral private key share, or the inverse may be generated when needed, e.g. using the INVSS function described above. Each participant may also have access to an ephemeral public key, i.e. a public key corresponding to the shared ephemeral private key. As is known in the art, a public key comprises first (x) and second (y) co-ordinates and, as will be discussed below, the first co-ordinate is used to generate the signature share. Each participant 102 may also have access to a respective message independent component (MIC) of the signature share, i.e. the signature share is generated based on the respective MIC. The MIC itself may be generated, by a given participant 102, based on the respective private key share and the respective ephemeral private key of that participant 102, and also the first co-ordinate of the ephemeral public key. The data required by each participant 102 will depend on the particular form of signature that is to be generated, e.g. an ECDSA signature.

All of the above data items (e.g. private key share, ephemeral key share, etc.) may be generated during a set-up phase prior to a signature phase. For example, the data items may be generated prior to receiving a request from the coordinator 104 to provide a signature share.

Each participant is associated with a respective index, referred to herein as a “participant index”. For instance, the first participant 102a is associated with a first participant index, the second participant 102b is associated with a second participant index, and so on. Each participant index may be an integer, e.g. “1” for the first participant 102a, “2” for the second participant 102b, and so on. The specific values of the participant indexes are not important, rather it is only important that each participant has a unique participant index.

The shared private key has a threshold, i.e. the private key can only be successfully generated based on at least the threshold number of different private key shares. Similarly, the signature has a threshold, meaning at least the threshold number of different signature shares are required to generate a valid signature. It should be appreciated that any reference to “the threshold” is taken to mean a number corresponding to the threshold of the private key. For example, the threshold may be two, or three, or ten, etc.

The first participant 102a generates a respective signature share based on a message. The message may have been obtained from the coordinator 104 (e.g. as part of a request for a signature share) or it may be known in advance to the first participant 102. The signature share is generated based on (i.e. is a function of) at least the first private key share. In some embodiments, the signature share is also generated based on the first ephemeral key share (or more specifically, the inverse thereof), the first co-ordinate of the ephemeral public key (or more specifically, the first co-ordinate mod n, where n is the order of the elliptic curve), the child private key, the message (or more specifically, a hash of the message), and the first MIC share.

The other participants (e.g. the second participant 102b) who intend to generate a respective signature share perform an equivalent process of generating a respective signature share.

The first participant 102a may send the first signature share to the coordinator 104 for generating a signature based on at least the threshold number of signature shares. Alternatively, the first participant 102a may be the coordinator 104, in which case the first participant 102a may obtain respective signature shares from respective participants, and then generate a signature based on the respective signature shares.

The coordinator 104 obtains at least the threshold number of signature shares. The coordinator 104 may obtain more than the threshold number, e.g. one from each participant 102.

The coordinator 104 also obtains a respective signature commitment for each signature share that is provided by a participant. In some examples, the signature share itself is the commitment. In other examples, the commitment is based on the signature share, e.g. the commitment may be a hash of the signature share.

In other examples, the commitment may be based on data that is used to derive the signature share. For instance, the commitment of a respective signature share may be based on the respective ephemeral private key share and the respective MIC that was used to derive the signature share. The commitment may also be based on the x-coordinate of the ephemeral public key, such as the r-value of the public key, where r=x mod n. A particular example of this form of commitment is provided further below. This form of commitment may be used to prove that a participant contributed a signature share without revealing the signature share itself.

Having obtained a respective commitment of each respective signature share, the coordinator 104 constructs a Merkle tree based on the respective commitments and the respective indexes of the participants that contributed the respective signature shares. More specifically, each commitment is mapped to (e.g. combined with, such as via concatenation) an index of the participant 102 that provided the commitment and then hashed to form a respective leaf hash of the Merkle tree. An example Merkle tree constructed in this way is shown in FIG. 2. In FIG. 2, each leaf hash of the Merkle tree is based on a respective data Dᵢ, where that data comprises a hash of a respective commitment and a respective participant index. The example Merkle tree in FIG. 2 corresponds to a scenario where eight participants 102 contribute respective signatures.

The coordinator 104 makes the Merkle root (which is node h₁₈ in the example of FIG. 2) available to the participants 102 that contributed respective signature shares. The coordinator 104 may send the Merkle root directly to the participants 102, or the Merkle root may be stored at a resource accessible by the participants, such as a webpage or on the 106. That is, the coordinator 104 may submit a blockchain transaction to the blockchain network 106, wherein the transaction includes the Merkle root, e.g. in an output of the transaction.

The coordinator 104 may send, to each participant 102 that contributed a signature share, a respective Merkle proof for proving that the respective index and commitment of that participant 102 was used to form a leaf hash of the Merkle tree having the Merkle root. In other examples, the coordinator 104 may send a Merkle proof only to participants who request a Merkle proof. The Merkle proof for a given leaf hash includes a set of hashes that would be required in order to derive the Merkle roof of the Merkle tree starting from that leaf hash. Normally, the given leaf hash itself is not included in the Merkle proof as it is known to or derivable by the prover (in this case a participant wanting to prove that they contributed a signature share). However, it is not excluded that in some examples the Merkle proof may include the given leaf hash. In other examples, a participant may obtain a Merkle proof in an alternative way. E.g. the coordinator 104 may publish the Merkle tree in its entirety (not including the data Dᵢ itself).

In some examples, the coordinator 104 may make the Merkle root (or Merkle tree) available to the participants (e.g. by publishing it on the blockchain) prior to generating the signature. This may allow the participants to verify the Merkle root has been calculated correctly, and raise an objection if it has not been calculated correctly. In some examples, each participant may use their respective Merkle proof to verify that the Merkle root has been calculated based on their signature commitment.

In some examples, the participants 102 may send their signature commitments to the coordinator 104 before sending their signature shares (of course, in these examples the signature commitment cannot be the signature share itself). For example, the participants 102 may send a hash of their respective signature share. In other examples where the signature commitment is not based on the signature share itself, the participants 102 may receive the Merkle root and include the Merkle root in the message to be signed, such that the signature share signs the Merkle root. In this way, the participants 102 attest to the Merkle root.

As is discussed further below, the signed message may comprise at least part of a blockchain transaction, e.g. one or more inputs and one or more outputs of the transaction. Depending on the signature commitment that is used, the signed transaction may include the Merkle root.

When a participant, e.g. the first participant 102a, wants or needs to prove that they have contributed a share of the signature, the participant 102 provides the necessary information to a verifying party (not shown in FIG. 1). That is, the participant provides their respective commitment (e.g. a signature share or hash thereof), their respective index, and a respective Merkle proof to the verifying party for verifying that the Merkle tree corresponding to the Merkle root was generated based on the respective commitment and index of the participant. The participant may also provide the Merkle root of the Merkle tree to the verifying party, or the Merkle root may be obtained from elsewhere, e.g. from the blockchain or from the coordinator 104.

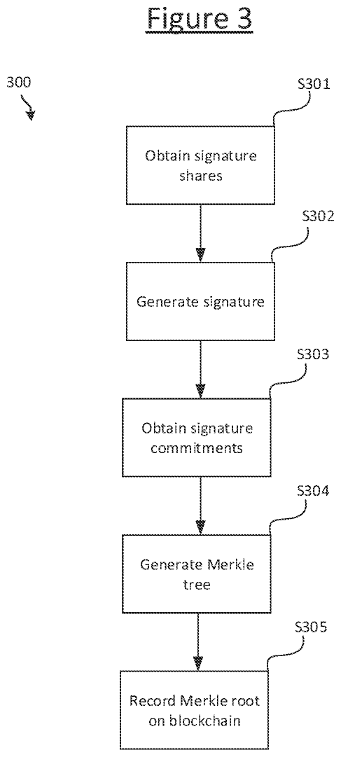

FIG. 3 shows an example method 300 according to some embodiments of the present invention. The steps S301 to S305 are performed by the coordinator 104. Note that at least some of the steps may be performed in a different order to how they are shown in FIG. 3. At step S301, the coordinator 104 obtains at least the threshold number of signature shares from the participants 102, and at step S302 the coordinator 104 generates a signature based on those signature shares. At step S303, the coordinator 104 obtains a respective commitment from each of the participants 102 that provides (or intends to provide) a signature share. At step S304, the coordinator 104 constructs a Merkle tree based on those commitments, and at step S305 the coordinator publishes the Merkle root of the Merkle tree on the blockchain.

The following provides further specific examples of the described embodiments.

As discussed above, a Merkle tree (or a root thereof) of the signature shares and indices of the signers may be created and stored in a blockchain transaction, e.g. in an OP_RETURN output. Then, anyone wanting to prove they signed a message (e.g. a blockchain transaction) may prove that their index and signature share is in the Merkle tree. An example of the structure of such a Merkle tree for eight signers is shown in FIG. 2. In FIG. 2, the node Di represents the data that is the index and signature share of participant i. The nodes hᵢᵢ is the hash of the data hash (Dᵢ) and then hᵢⱼ is notation for hash(hᵢₖ∥h₍ₖ₊₁₎ⱼ) where

$$k = \frac{i + j - 1}{2} .$$

As an example, in order for participant 5 to prove that they have contributed a signature, they simply need to provide the data at nodes D₅, h₆₆, h₇₈, and h₁₄. A verifier would then be able to calculate the result h₁₈ and confirm this is the same as the Merkle root. A verifier does not learn any information about the other data Di without being given that data explicitly. Note that if the number of required data to include in the root is not of the form 2^{x} (where x is any positive integer), then there are 0's padded as extra leaves to create the next number of leaves that can be written as 2^{x}. As another example, rather than padding the Merkle trees with extra leaves whereby the leaves are 0's, then any leaf hash that is not paired with a leaf hash may be paired with itself. In other words, a leaf hash may be concatenated with itself (i.e. the leaf hash is duplicated) and then hashed in order to form a node of the next layer in the Merkle tree.

The coordinator 104 of the group calculates this Merkle tree where Dᵢ=(i, sᵢ) when they receive enough signature shares. If more than the threshold number of participants respond, the coordinator 104 may still include those participants in the Merkle tree. This could then be used as evidence that the participants agreed to sign.

Once the coordinator 104 has created this Merkle tree, they may return the relevant data (e.g. Merkle root, Merkle proof, etc.) to each participant, and additionally broadcast the Merkle root. Each participant 102 may then verify that they all have the same Merkle root that has been broadcast to confirm that they have been given the correct information. If it is found that the coordinator has produced the incorrect tree, the coordinator will be punished and thereby disincentivised to act dishonestly.

In some use cases it may be beneficial to be able to provide proof that the Merkle root was created before the signature. If it is created after, then there is no attestation from the signers that they verify this Merkle root. By creating it before, the act of signing is a form of attestation on the Merkle root being correct. A timestamp of when the Merkle root was generated may be obtained by storing the Merkle root on the blockchain.

If the message being signed is a general message (i.e. not necessarily a blockchain transaction), this Merkle root may be stored as data in the (OP_RETURN) output of a transaction on the blockchain which may be referenced when required. This may be a service that is provided by a trusted third party, attesting that the signers are those as claimed. On the other hand, if the threshold signature is signing a message that will contain the Merkle root, such as a blockchain transaction, there are a few subtleties to consider. If one attempts to include this Merkle root immediately in the message that is being signed, then the group need to be careful to not invalidate a signature in the following way. For instance, a coordinator 104 may request a signature on a message and send the message to be signed to the participants. The participants 102 create their signature share and return to the coordinator. The coordinator 104 creates the signature, and the Merkle tree. The coordinator then attempts to include this Merkle root in the message such as by concatenating on the end of the message or if the message is a blockchain transaction, it may be included in an output field of the transaction. Once the coordinator does this, they now invalidate the signature on the message and must ask for another signature share by each participant.

A way around this is for the coordinator to initially request participants who agree to sign to create the commitment kᵢrσᵢG and return this to the coordinator. This specific commitment is selected as it is message independent and can be verified once the coordinator receives the signature share of participant i. Note that the signature share in this example is generated as

$${s}_{i} = {k}_{i}^{- 1} e + r {σ}_{i} . \\ This implies \\ {s}_{i} {k}_{i} = e + {k}_{i} r {σ}_{i} . \\ Therefore , \\ {s}_{i} {k}_{i} G - e G = {k}_{i} r {σ}_{i} G .$$

The last equation can be used to verify the commitment of the message independent component as the value of sᵢ, kᵢG, e, G, and kᵢrσᵢG are known to the coordinator after the signature shares are sent.

Note that this assumes that once a participant shares this value kᵢrσᵢG, they do not change their mind as the value is their commitment to the signature. The coordinator selects the first t+1 who respond to this request and creates a Merkle tree including these values as the leaves Dᵢ for those participants, for example Dᵢ being ‘Participant i is contributing to this signature’ concatenated with kᵢrσᵢG. The coordinator broadcasts this to the group, and provided this tree is correctly constructed, with those t+1 chosen signers verifying their Merkle branch and the Merkle root, they create their signature shares on a message including the Merkle root and return their share to the coordinator to create the signature. Note that the Merkle root may then be used whenever a signer is required to prove they contributed.

One attack on this approach is that if the coordinator receives more than 2t commitments, the coordinator will be able to work out the commitment for each participant in the group. It is possible for the coordinator to collude with a contributing signer and construct a tree that includes a non-signer instead of the colluded signer. To mitigate this issue, a restriction on the number of commitments received by the coordinator can be implemented. For example, a single thread process with a counter can be implemented on the coordinator side to deal with the incoming messages that contains the commitments.

An alternative to the approach above is to assume that there are at most t dishonest participants and all honest signers will verify the Merkle tree in its entirety to ensure it captures both signers and non-signers before they create their signature share. This allows a group to reflect who had the intention to sign, rather than only those that contributed to the signature generation.

To do this the participants may instead create and sign a Merkle root which reflects those that intended to sign. As above, the coordinator first requests a signature, and those who want to sign return a message stating their desire to sign with the value kᵢrσᵢG. The coordinator creates a Merkle tree where the data Dᵢ is a statement such as ‘Participant i agrees to this signature’ concatenated with kᵢrσᵢG. The coordinator broadcasts this to the group, and provided this tree is correctly constructed, with all available participants verifying the correct intended signers are included and all non-signers are excluded, the signers create their signature shares on a message including this Merkle tree (or only the Merkle root). In this process, the signers sign the Merkle root, attesting to its correctness. Note that those non-signers depend on the contributing signers being diligent and honest to verify and attest the correctness of the Merkle tree.

One may think that there is a risk of an incorrect Merkle root being signed. However, since it is assumed that there are at most t dishonest participants, a signature will never be created with an incorrect Merkle root. This is because the threshold required to create a signature will not be reached on a message containing an incorrect Merkle root. This would require an honest participant to deviate from the protocol which contradicts the definition of an honest participant.

A Merkle tree of the signers can be seen as an attestation to the signature. Given a signature and a Merkle tree, a verifier (e.g. an auditor) may verify that the leaves of the Merkle tree indeed contains the signers.

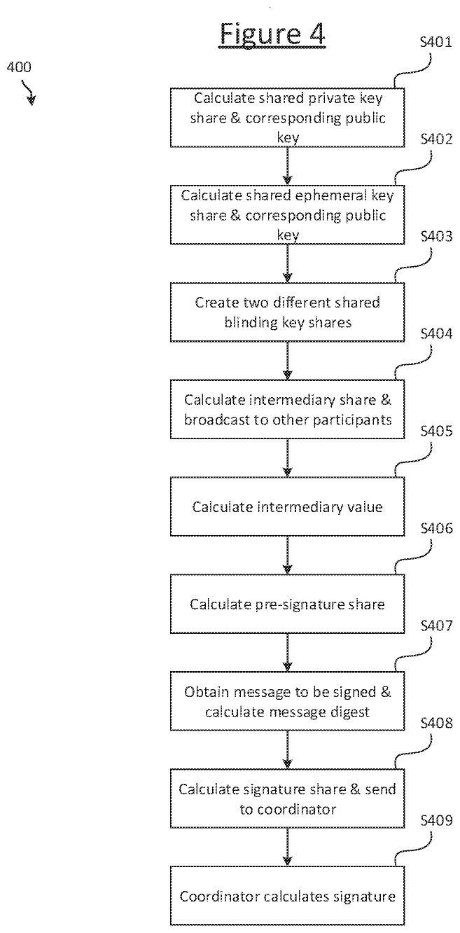

FIG. 4 illustrates an example method 400 for generating a signature on a message according to embodiments of the invention. Steps S401 to S408 are performed by each of a threshold number of participants 102 in this example (including the first participant 102a). Step S409 is performed by a coordinator 101, who may also be one of the participants performing steps S401 to S408. It will be appreciated that some of the steps may be omitted or be performed in a different order.

The example method 400 enables the creation of a shared secret of threshold (t+1) in a group of N≥2t+1 participants, where the signing threshold is also (t+1).

Set-up:

In step S401, each participant 102 calculates a shared private key share aᵢ and a corresponding public key. The private key share may be generated using JVRSS as described above. At this point, each participant i has a secret key share and public key (aᵢ, P), where P is notation for the public key corresponding to the shared private key. The shared private key has a threshold of (t+1).

Pre-calculation:

In step S402, each participant 102 calculates a shared ephemeral key share and a corresponding public key. For instance, each participant 102 may calculate a shared ephemeral key using JVRSS and the calculation of the public key given in the preliminaries. Each participant 102 may then calculate an inverse share based on the ephemeral private key. This results in each participant having an inverse share (kᵢ⁻¹, r), with a threshold of (t+1).

In step S403, each participant 102 creates two different shared blinding key shares. For instance, each participant 102 may create two shared secrets so that participant i has shares αᵢ=JVRSS(i) and βᵢ=JVRSS(i), each shared secret having a threshold (t+1). Note that in some examples, not all of the shared secrets need to have the same threshold.

In step S404, each participant 102 calculates an intermediary share and broadcasts their intermediary share to the other participants. For instance, each participant i may calculate the intermediary share λᵢ=kᵢ⁻¹aᵢr+βᵢ. This value has a threshold of (2t+1).

In step S405, the first participant 102a calculates an intermediary value based on at least the intermediary shares. For instance, the first participant 102a may calculate the intermediary value using interpolation over (2t+1) shares λ=interpolate(λ₁, . . . , λ₂ₜ₊₁)=k⁻¹ar+β.

In step S406, the first participant 102a has knowledge of (r, kᵢ⁻¹, λ, βᵢ) and stores this along with the private key share and corresponding public key (aᵢ, P).

Note that since a different ephemeral key is used for each signature, multiple ephemeral keys can be set up at one time, that is, steps S402 to S406 can be repeated to create multiple ephemeral keys during pre-calculation and stored for later use. These can be executed at the same time so that there are no additional rounds of communication. Note that preferably, a different value of a and B should be used for each signature.

Signature generation:

In order to sign a message msg, at least (t+1) participants must perform steps S407 and S408. In step S407, at least the threshold number of participants 102 obtain a message to be signed and calculate a message digest. For instance, a coordinator 101 may send a request to (t+1) participants to create a signature share on the message msg. Each participant i may calculate the message digest e=hash(msg). In some examples, this hash function is the double SHA-256 hash function. Alternative hash functions may be used.

In step S408, at least the threshold number of participants 102 calculate a signature share and send it to the coordinator 101. For instance, each participant i may calculate their signature share sᵢ=kᵢ⁻¹e−βᵢ, and then send this signature share (r, sᵢ) to the coordinator. Note that the value r may not be sent by all participants.

In step S409, the coordinator 101 calculates the signature. For instance, the coordinator 101 may calculate s=interpolate(s₁, . . . , sₜ₊₁)+λ=k⁻¹e+k⁻¹ar, and finally the signature (r, s). This results in the expected signature share since the β terms cancel. Similar variations of this protocol can be made as above describing when the (kα)⁻¹ and r is included in the calculation.

Note that the thresholds of the secrets may be different. That is the threshold of a, k, α, β themselves do not necessarily need to be the same to execute the signature generation scheme. For example, if there is a group of six and three are needed to create the signature and/or private key, they could technically do the calculation with the threshold of the k being four and the thresholds of the other shared secrets being three, and they will still have a threshold-optimal scheme.

Note that the present invention may be applied to any threshold signature scheme (whether optimal or non-optimal) and is not limited to the example of FIG. 4 described above.

In general, embodiments of the present invention can be used to generate a signature on any message. As a particular example use case, as shown in FIG. 1, the message may be part or all of a blockchain transaction. That is, the signature may be used to sign one or more inputs and/or one or more outputs of a blockchain transaction. For instance, the generated signature may be used, at least in part, to unlock an output of a blockchain transaction. As a particular example, the output of a previous transaction may be a pay-to-public-key-hash (P2PKH) output which is locked to a hash of a public key. In order to be unlocked, an input of a later transaction that references the P2PKH output needs to include the (unhashed) public key and a signature generated based on the private key corresponding to the public key. The coordinator 104 may sign the blockchain transaction and submit the signed transaction to one or more blockchain nodes of a blockchain network 106.

Represented in script, the “locking script” and “unlocking script” may take the following forms:

Locking script=OP_DUP OP_HASH160<Public KeyHash>OP_EQUAL OP_CHECKSIG Unlocking script=<Signature><Public Key>.

Referring to the above described embodiments, the <Public Key> may be equated to P=a_{child}·G, and the <Signature> comprises the threshold signature s, where the previous transaction is the message to be signed. Note that as stated above, ECDSA signatures are in the form (r, s).

Note that the described signature generation method is not limited to any particular use case and may in general be used for generating a signature based on any message. Signing all or part of a blockchain transaction is just one illustrative example. The described method may be used to sign and/or authorise, for instance, a legal document (e.g. a will, deed or other contract), correspondence between one or more parties, digital certificates (e.g. issued by a certificate authority), medical prescriptions, a bank transfer or a financial instrument, a mortgage or loan applications, etc.

As a particular example, the group of participants (say five participants in total) may form the board of a company. Voting matters of the company may require a majority of the board (i.e. at least three participants) to agree on the particular vote. The board may use the described signature generation method to prove that at least three board members agreed to vote in favour of a particular outcome. In this example, the threshold of the signature generation scheme is three. That is, at least three of the board members must provide a respective signature share in order for the co-ordinator to successfully generate a signature. If a signature is generated successfully, at least the threshold number (i.e. three) of board members must have agreed to vote in favour of that outcome. Thus the successful generation of a signature acts as a record of the vote and proves that a majority of the board voted in a particular way.

Another use case for the present invention lays in the field of digital certificates, e.g. digital certificate issued by the X.509 standard. A digital certificate contains a signature that signs over some data. The data can in general be any data, but one particular example of data included in a digital certificate is a public key. A public key in a digital certificate is often referred to as a “certified public key”. The issuer of the digital certificate (a “certificate authority”) may perform one or more checks on the owner of the public key (e.g. know-your-customer checks), and if the checks are successful, the certificate authority issues a digital certificate that includes the certified public key. A user can use a certified public key to prove they are who they say they are, e.g. by signing a message with a private key corresponding to the certified public key. One particular use for certificate authorities is to sign certificates used in HTTPS for secure browsing on the internet. Another common use is in issuing identity cards by national governments for use in electronically signing documents. The certificate authority signs the public key (or any other data to be attested to) using a private key.

As stated above, embodiments of the present invention may involve encrypting a message with a public key corresponding to a private key share, and similarly decrypting the message with a private key share. In that case, the first participant 102a may decrypt the message that has been encrypted by a different party. As another option, a message may be encrypted with a public key corresponding to a full private key, e.g. a full child key. In that case, at least a threshold number of participants may make their respective shares of the child private key available in order to decrypt the message. The message that is encrypted may comprise some or all of a blockchain transaction, e.g. encrypted data may be included in a transaction to be recorded on the blockchain.

### Conclusion

Other variants or use cases of the disclosed techniques may become apparent to the person skilled in the art once given the disclosure herein. The scope of the disclosure is not limited by the described embodiments but only by the accompanying claims.

It will be appreciated that the above embodiments have been described by way of example only. More generally there may be provided a method, apparatus or program in accordance with any one or more of the following Statements.

Statement 1. A computer-implemented method of generating a digital signature for signing a message, wherein each participant of a group of participants has a respective private key share of a shared private key, wherein the shared private key can only be generated with at least a threshold number of respective private key shares, wherein each participant is associated with a respective participant index, and wherein the method is performed by a coordinating party and comprises:
obtaining at least the threshold number of respective signature shares, each respective signature having been generated by a respective participant based on the respective private key share;
obtaining, for each of the respective signature shares, a respective commitment of the respective signature share, each respective commitment having been generated by the respective participant that generated the respective signature share;
generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
generating the signature based on at least the threshold number of respective signature shares; and
making a Merkle root of the Merkle tree available to at least the respective participants that generated a respective signature share.

Statement 2. The method of claim 1, comprising:
sending, to each respective participant that generated a respective signature share, a respective Merkle proof, wherein the respective Merkle proof is based on the respective leaf node of the Merkle tree that is generated based on the respective participant index associated with that respective participant.

Statement 3. The method of statement 1 or statement 2, wherein said making of the Merkle root available comprises sending the Merkle root to at least the respective participants that generated a respective signature share.

Statement 4. The method of any preceding statement, wherein said making of the Merkle root available comprises submitting a first blockchain transaction to a blockchain network, wherein the blockchain network comprises the Merkle root.

Statement 5. The method of any preceding statement, wherein the method comprises performing said making of the Merkle root available prior to performing said generating of the signature.

Statement 6. The method of statement 5, wherein the respective signature share is based on a message comprising the Merkle root.

Statement 7. The method of any preceding statement, wherein the respective commitment of the respective signature share comprises the respective signature share.

Statement 8. The method of any of statements 1 to 6, wherein each participant has a respective ephemeral private key share of a shared ephemeral private key, a first co-ordinate of an ephemeral public key corresponding to the shared ephemeral private key, and a respective share of a message-independent component, MIC, of the respective signature share, wherein each respective share of the MIC is generated based on the respective ephemeral private key share, the respective private key share and the first co-ordinate of the ephemeral public key, and wherein the respective commitment of the respective signature share is based on the respective ephemeral private key share, the first co-ordinate of an ephemeral public key, the respective share of the MIC, and an elliptic curve generator point.

Statement 9. The method of any preceding statement, wherein the message comprises at least part of a second blockchain transaction.

Statement 10. The method of statements 4, 8 and 9, wherein the first blockchain transaction is the second blockchain transaction.

Statement 11. A computer-implemented method, performed by a first participant of a group of a participants, of proving that the first participant has generated a respective signature share of a digital signature for signing a message, wherein each participant of the group has a respective private key share of a shared private key, wherein the shared private key can only be generated with at least a threshold number of respective private key shares, wherein each participant is associated with a respective participant index, and wherein the method comprises:
generating a first signature share based on a first private key share and the message;
generating a first commitment of the first signature share,
providing a) the first signature share and b) the first commitment to a coordinating party for generating, respectively, a) a signature based on at least the threshold number of respective signature shares, and b) a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
obtaining a Merkle root of the Merkle tree;
obtaining a Merkle proof based on a respective leaf node of the Merkle tree that is generated based on the respective participant index associated with the first participant; and
providing at least the Merkle proof, the first commitment and the first participant index to a verifying party for verifying that a leaf node of the Merkle tree having the Merkle root was generated based on the first commitment and the first participant index, thereby verifying that the coordinating party generated the signature based on the first signature share.

Statement 12. The method of statement 11, comprising providing the Merkle root to the verifying party.

Statement 13. The method of statement 11, wherein said obtaining of the Merkle root comprises receiving the Merkle root from the coordinating party.

Statement 14. The method of statement 11, wherein a first blockchain transaction stored on a blockchain comprises the Merkle root, and wherein the said obtaining of the Merkle root comprises obtaining the Merkle root from the blockchain.

Statement 15. The method of statement 11 or any statement dependent thereon, wherein the message comprises the Merkle root.

Statement 16. The method of statement 11 or any statement dependent thereon, wherein the first commitment of the first signature share comprises the first signature share.

Statement 17. The method of any of statements 11 to 15, wherein each participant has a respective ephemeral private key share of a shared ephemeral private key, a first co-ordinate of an ephemeral public key corresponding to the shared ephemeral private key, and a respective share of a message-independent component, MIC, of the respective signature share, wherein each respective share of the MIC is generated based on the respective ephemeral private key share, the respective private key share and the first co-ordinate of the ephemeral public key, and wherein the first commitment of the first signature share is based on a first ephemeral private key share, the first co-ordinate of the ephemeral public key, the first share of the MIC, and an elliptic curve generator point.

Statement 18. The method of statement 11 or any statement dependent thereon, wherein the message comprises at least part of a second blockchain transaction.

Statement 19. The method of statements 14, 17 and 18, wherein the first blockchain transaction is the second blockchain transaction.

Statement 20. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 19.

Statement 21. A computer program embodied on computer-readable storage and configured so as, when run on one or more processors, to perform the method of any of statements 1 to 19.

According to another aspect disclosed herein, there may be provided a method comprising the actions of the coordinating party and the first participant.

According to another aspect disclosed herein, there may be provided a system comprising the computer equipment of the coordinating party and the first participant.

1. A computer-implemented method of generating a digital signature for signing a message, wherein each participant of a group of participants has a respective private key share of a shared private key, wherein the shared private key can only be generated with at least a threshold number of respective private key shares, wherein each participant is associated with a respective participant index, and wherein the method is performed by a coordinating party and comprises:
obtaining at least the threshold number of respective signature shares, each respective signature having been generated by a respective participant based on the respective private key share;
obtaining, for each of the respective signature shares, a respective commitment of the respective signature share, each respective commitment having been generated by the respective participant that generated the respective signature share;
generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
generating the signature based on at least the threshold number of respective signature shares; and
making a Merkle root of the Merkle tree available to at least the respective participants that generated a respective signature share.

2. The method of claim 1, comprising:
sending, to each respective participant that generated a respective signature share, a respective Merkle proof, wherein the respective Merkle proof is based on the respective leaf node of the Merkle tree that is generated based on the respective participant index associated with that respective participant.

3. The method of claim 1, wherein said making of the Merkle root available comprises sending the Merkle root to at least the respective participants that generated a respective signature share.

4. The method of claim 1, wherein said making of the Merkle root available comprises submitting a first blockchain transaction to a blockchain network, wherein the blockchain network comprises the Merkle root.

5. The method of claim 1, wherein the method comprises performing said making of the Merkle root available prior to performing said generating of the signature.

6. The method of claim 5, wherein the respective signature share is based on a message comprising the Merkle root.

7. The method of claim 1, wherein the respective commitment of the respective signature share comprises the respective signature share.

8. The method of 1, wherein each participant has a respective ephemeral private key share of a shared ephemeral private key, a first co-ordinate of an ephemeral public key corresponding to the shared ephemeral private key, and a respective share of a message-independent component, MIC, of the respective signature share, wherein each respective share of the MIC is generated based on the respective ephemeral private key share, the respective private key share and the first co-ordinate of the ephemeral public key, and wherein the respective commitment of the respective signature share is based on the respective ephemeral private key share, the first co-ordinate of an ephemeral public key, the respective share of the MIC, and an elliptic curve generator point.

9. The method of claim 1, wherein the message comprises at least part of a second blockchain transaction.

10. (canceled)

11. A computer-implemented method, performed by a first participant of a group of a participants, of proving that the first participant has generated a respective signature share of a digital signature for signing a message, wherein each participant of the group has a respective private key share of a shared private key, wherein the shared private key can only be generated with at least a threshold number of respective private key shares, wherein each participant is associated with a respective participant index, and wherein the method comprises:
generating a first signature share based on a first private key share and the message;
generating a first commitment of the first signature share,
providing a) the first signature share and b) the first commitment to a coordinating party for generating, respectively, a) a signature based on at least the threshold number of respective signature shares, and b) a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
obtaining a Merkle root of the Merkle tree;
obtaining a Merkle proof based on a respective leaf node of the Merkle tree that is generated based on the respective participant index associated with the first participant; and
providing at least the Merkle proof, the first commitment and the first participant index to a verifying party for verifying that a leaf node of the Merkle tree having the Merkle root was generated based on the first commitment and the first participant index, thereby verifying that the coordinating party generated the signature based on the first signature share.

12. The method of claim 11, comprising providing the Merkle root to the verifying party.

13. The method of claim 11, wherein said obtaining of the Merkle root comprises receiving the Merkle root from the coordinating party.

14. The method of claim 11, wherein a first blockchain transaction stored on a blockchain comprises the Merkle root, and wherein the said obtaining of the Merkle root comprises obtaining the Merkle root from the blockchain.

15. The method of claim 11, wherein the message comprises the Merkle root.

16. The method of claim 11, wherein the first commitment of the first signature share comprises the first signature share.

17. The method of claim 11, wherein each participant has a respective ephemeral private key share of a shared ephemeral private key, a first co-ordinate of an ephemeral public key corresponding to the shared ephemeral private key, and a respective share of a message-independent component, MIC, of the respective signature share, wherein each respective share of the MIC is generated based on the respective ephemeral private key share, the respective private key share and the first co-ordinate of the ephemeral public key, and wherein the first commitment of the first signature share is based on a first ephemeral private key share, the first co-ordinate of the ephemeral public key, the first share of the MIC, and an elliptic curve generator point.

18. The method of claim 11, wherein the message comprises at least part of a second blockchain transaction.

19. (canceled)

20. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a digital signature for signing a message, wherein each participant of a group of participants has a respective private key share of a shared private key, wherein the shared private key can only be generated with at least a threshold number of respective private key shares, wherein each participant is associated with a respective participant index, wherein the method comprises:
obtaining at least the threshold number of respective signature shares, each respective signature having been generated by a respective participant based on the respective private key share;
obtaining, for each of the respective signature shares, a respective commitment of the respective signature share, each respective commitment having been generated by the respective participant that generated the respective signature share;
generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
generating the signature based on at least the threshold number of respective signature shares; and
making a Merkle root of the Merkle tree available to at least the respective participants that generated a respective signature share.

21. A computer program embodied on non-transitory computer-readable storage media and configured so as, when run on one or more processors, the one or more processors perform a method of generating a digital signature for signing a message, wherein each participant of a group of participants has a respective private key share of a shared private key, wherein the shared private key can only be generated with at least a threshold number of respective private key shares, wherein each participant is associated with a respective participant index, wherein the method comprises:
obtaining at least the threshold number of respective signature shares, each respective signature having been generated by a respective participant based on the respective private key share;
obtaining, for each of the respective signature shares, a respective commitment of the respective signature share, each respective commitment having been generated by the respective participant that generated the respective signature share;
generating a Merkle tree, wherein at least the threshold number of respective leaf nodes of the Merkle tree comprise a respective hash of a respective signature commitment combined with a respective participant index, wherein the respective participant index is associated with the respective participant that generated the respective signature commitment;
generating the signature based on at least the threshold number of respective signature shares; and
making a Merkle root of the Merkle tree available to at least the respective participants that generated a respective signature share.
